(19) United States
(12) Patent Application Publication
(10) Pub. No.: US 2013/0182324 A1
(43) Pub. Date: Jul. 18, 2013

(54) ADHESIVE LAYER FOR OPTICAL FILM, METHOD FOR PRODUCING SAME, OPTICAL FILM WITH ADHESIVE LAYER, AND IMAGE DISPLAY DEVICE

(71) Applicants: Kunihiro Inui, Ibaraki-shi (JP); Toshitsugu Hosokawa, Ibaraki-shi (JP); Takaaki Ishii, Ibaraki-shi (JP); Masayuki Satake, Ibaraki-shi (JP); Kazuto Yamagata, Ibaraki-shi (JP)

(72) Inventors: Kunihiro Inui, Ibaraki-shi (JP); Toshitsugu Hosokawa, Ibaraki-shi (JP); Takaaki Ishii, Ibaraki-shi (JP); Masayuki Satake, Ibaraki-shi (JP); Kazuto Yamagata, Ibaraki-shi (JP)

(73) Assignee: NITTO DENKO CORPORATION, Ibaraki-shi, Osaka (JP)

(21) Appl. No.: 13/822,499

(22) PCT Filed: Sep. 13, 2011
(86) PCT No.: PCT/JP2011/070862

§ 371 Date: Mar. 12, 2013

(30) Foreign Application Priority Data
Sep. 21, 2010 (JP) 2010-211128
Aug. 29, 2011 (JP) 2011-186052

(51) Int. Cl. C09J 133/12; G02B 5/30

(52) U.S. Cl. CPC C09J 133/12; G02B 5/30
USPC 359/494.01; 427/208.4; 428/327; 524/561

(57) ABSTRACT

The pressure-sensitive adhesive layer for an optical film of the invention is formed by a process comprising applying a water-dispersible pressure-sensitive adhesive containing emulsion particles comprising polymer particles emulsified with a surfactant and then drying the applied water-dispersible pressure-sensitive adhesive, and is in such a state that the polymer particles have a number average particle size (a) of 10 nm to 100 nm and that the ratio (a/b) of the number average particle size (a) to the average distance (b) between adjacent polymer particles is from 80/20 to 99.9/0.1, when the pressure-sensitive adhesive layer being observed with a transmission electron microscope. The pressure-sensitive adhesive layer makes it possible to reduce depolarization even when it is used on a high-contrast polarizing plate or any other component having a high degree of polarization.

### TECHNICAL FIELD

The present invention relates to a pressure-sensitive adhesive layer for an optical film formed from a water-dispersible pressure-sensitive adhesive and to a method for producing thereof. The present invention also relates to a pressure-sensitive adhesive layer-attached optical film including an optical film and the pressure-sensitive adhesive layer provided thereon. The present invention also relates to an image display device such as a liquid crystal display device, an organic electroluminescence (EL) display device, a cathode-ray tube (CRT), or a plasma display device panel (PDP) produced using the pressure-sensitive adhesive layer-attached optical film and to a part used together with an image display device, such as a front face plate, produced using the pressure-sensitive adhesive layer-attached optical film. Examples of the optical film that may be used include a polarizing plate, a retardation plate, an optical compensation film, a brightness enhancement film, a surface treatment film such as an anti-reflection film, and a laminate of any combination thereof.

### DESCRIPTION OF THE RELATED ART

Liquid crystal display devices, organic EL display devices, etc. have an image-forming mechanism including polarizing elements as essential components. For example, therefore, in a liquid crystal display device, polarizing elements are essentially placed on both sides of a liquid crystal cell, and generally, polarizing plates are attached as the polarizing elements. Besides polarizing plates, various optical elements have been used in display device panels such as liquid crystal panels and organic EL panels for improving display device quality. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal display devices, brightness enhancement films for increasing the contrast of display devices, and surface treatment films such as hard-coat films for use in imparting scratch resistance to surfaces, antiglare treatment films for preventing glare on image display devices, and anti-reflection films such as anti-reflective films and low-reflective films. These films are generically called optical films.

When such optical films are bonded to a display device panel such as a liquid crystal cell or an organic EL panel or bonded to a front face plate, a pressure-sensitive adhesive is generally used. In the process of bonding an optical film to a display device panel such as a liquid crystal cell or an organic EL panel or to a front face plate or bonding optical films together, a pressure-sensitive adhesive is generally used to bond the materials together so that optical loss can be reduced. In such a case, a pressure-sensitive adhesive layer-attached optical film including an optical film and a pressure-sensitive adhesive layer previously formed from the pressure-sensitive adhesive on one side of the optical film is generally used, because it has some advantages such as no need for a drying process to fix the optical film.

An organic solvent-type pressure-sensitive adhesive is generally used to form the pressure-sensitive adhesive layer of the pressure-sensitive adhesive layer-attached optical film, because it has good durability in a heated environment or a heated and humidified environment. In recent years, solvent-free pressure-sensitive adhesives, which are produced with no organic solvent, have been developed aggressively in view of a reduction in global environmental loading or an improvement in process stability.

For example, proposed solvent-free pressure-sensitive adhesives include water-dispersible pressure-sensitive adhesives containing a pressure-sensitive adhesive polymer component dispersed in water used as a dispersion medium. For example, there is proposed an adhesive or pressure-sensitive adhesive including an aqueous emulsion containing an emulsion having particle sizes controlled within a specific range (Patent Documents 1 to 3). It is disclosed that such an adhesive or pressure-sensitive adhesive has good water resistance or good water-whitening resistance. There is also proposed a water-dispersible pressure-sensitive adhesive for use on an optical film, which includes a water-dispersible acryl-based copolymer with a specific composition, a clay mineral, and a dispersing component (Patent Document 4). It is disclosed that such a water-dispersible pressure-sensitive adhesive can form a pressure-sensitive adhesive layer-attached optical film with a low haze value and good transparency.

### PRIOR ART DOCUMENTS

### Patent Documents

Patent Document 1: JP-A-09-278837
Patent Document 2: JP-A-2000-109784
Patent Document 3: JP-A-2004-123961
Patent Document 4: JP-A-2010-006896

### SUMMARY OF THE INVENTION

### Problems to be Solved by the Invention

Image display devices such as liquid crystal display devices and organic electroluminescent (EL) display devices and components used together with image display devices, such as front plate, are required to produce an image with a good appearance. In particular, liquid crystal display devices are required to have a high contrast between display in white and display in black. Various components for increasing the contrast of liquid crystal display devices have been developed. For this purpose, components for use in liquid crystal display devices, such as pressure-sensitive adhesive layers, are required not to interfere with the increase in contrast.

Components for use in liquid crystal display devices are required not to cause depolarization so that the increase in contrast is not interfered with. Particularly in a liquid crystal display device, components inside two polarizing plates placed on both sides of a liquid crystal cell with a pressure-sensitive adhesive layer interposed therebetween (such as a liquid crystal cell-side transparent protective film of the polarizing plate, the pressure-sensitive adhesive layer, and the liquid crystal cell) are required not to cause depolarization.

When a water-dispersible pressure-sensitive adhesive including an aqueous emulsion containing emulsion particles (which refer to a state where polymer particles are emulsified with a surfactant) is used, the emulsion particles are gathered by drying to form a pressure-sensitive adhesive layer. Thus, it has been found that since such a pressure-sensitive adhesive layer has interfaces between many polymer particles, light scattering occurs at the interfaces between the polymer particles to cause depolarization. In cases where a conventional low-contrast polarizing plate or liquid crystal cell is used, depolarization does not particularly cause a problem even when the pressure-sensitive adhesive used on the polarizing plate is formed using a water-dispersible pressure-sensitive adhesive. However, as a result of the development of various polarizing plates and liquid crystal cells having higher contrast as mentioned above, there is a problem in that a conventional water-dispersible pressure-sensitive adhesive causes depolarization to reduce contrast when a pressure-sensitive adhesive layer formed using it is provided on a high-contrast polarizing plate or any other component having a high degree of polarization.

The pressure-sensitive adhesive layer formed using the water-dispersible pressure-sensitive adhesive disclosed in Patent Documents 1 to 3 produces an advantageous effect such as a low level of physical property change or a low level of cloudiness when it is immersed in water. Unfortunately, the use of the pressure-sensitive adhesive layer formed using the water-dispersible pressure-sensitive adhesive disclosed in Patent Documents 1 to 3 does not make it possible to reduce depolarization or to produce a pressure-sensitive adhesive layer-attached optical film capable of providing a high contrast. Patent Document 4 discloses a pressure-sensitive adhesive layer having a low haze value, a high transmittance, and reliable transparency. However, the haze value is not a measure of polarized light transmittance, and reducing the haze value does not mean a reduction in depolarization.

It is an object of the present invention to provide a pressure-sensitive adhesive layer for an optical film, which is formed using a water-dispersible pressure-sensitive adhesive and makes it possible to reduce depolarization even when it is used on a high-contrast polarizing plate or any other component having a high degree of polarization. It is another object of the present invention to provide a method for producing such a pressure-sensitive adhesive layer for an optical film.

It is another object of the present invention to provide a pressure-sensitive adhesive layer-attached optical film including an optical film and the pressure-sensitive adhesive layer for an optical film placed on at least one side of the optical film. A further object of the present invention is to provide an image display device including the pressure-sensitive adhesive layer-attached optical film.

### Means to Solve the Problems

As a result of earnest studies to solve the above problems, the inventors have accomplished the present invention based on the finding that the pressure-sensitive adhesive layer for an optical film etc., described below can solve the problems.

The present invention relates to a pressure-sensitive adhesive layer for an optical film,

the pressure-sensitive adhesive layer being formed by a process including applying a water-dispersible pressure-sensitive adhesive containing emulsion particles including polymer particles emulsified with a surfactant and then drying the applied water-dispersible pressure-sensitive adhesive, and

the pressure-sensitive adhesive layer being in such a state that the polymer particles have a number average particle size (a) of 10 nm to 100 nm and that the ratio (a/b) of the number average particle size (a) to the average distance (b) between adjacent polymer particles is from 80/20 to 99.9/0.1, when the pressure-sensitive adhesive layer being observed with a transmission electron microscope.

In the pressure-sensitive adhesive layer for an optical film, the pressure-sensitive adhesive layer preferably has a residual water content of 0.1% by weight to 1% by weight at 23° C. and 55% R.H.

In the pressure-sensitive adhesive layer for an optical film, a difference between a refractive index of the pressure-sensitive adhesive layer and a refractive index of the surfactant is preferably 0.1 or less.

In the pressure-sensitive adhesive layer for an optical film, the polymer particles preferably have a number average particle size (a) of 10 nm to 90 nm.

In the pressure-sensitive adhesive layer for an optical film, the water-dispersible pressure-sensitive adhesive preferably contains emulsion particles including acryl-based polymer particles obtained by emulsion polymerization of, in the presence of a radical polymerization initiator and a surfactant, a monomer component containing 60 to 99.9% by weight of an alkyl (meth)acrylate having a straight or branched chain alkyl group of 3 to 14 carbon atoms and 0.1 to 10% by weight of a carboxyl group-containing monomer.

In the pressure-sensitive adhesive layer for an optical film, the monomer component preferably contains 39% by weight or less of a copolymerizable monomer, and the copolymerizable monomer includes a high-Tg monomer capable of forming a homopolymer with a glass transition temperature (Tg) of 50° C. or more. The Preferable high-Tg monomer is a styrene monomer and/or an alkyl methacrylate having an alkyl group of 1 or 2 carbon atoms.

In the pressure-sensitive adhesive layer for an optical film, the drying in the process of forming the pressure-sensitive adhesive layer is preferably performed at a temperature 100° C. or more higher than a glass transition temperature (Tg) of the pressure-sensitive adhesive layer.

The present invention also relates to a method for producing the pressure-sensitive adhesive layer for an optical film,

the method including the steps of: applying a water-dispersible pressure-sensitive adhesive containing emulsion particles including polymer particles emulsified with a surfactant; and drying the applied water-dispersible pressure-sensitive adhesive to form the pressure-sensitive adhesive layer, wherein

the drying is performed at a temperature 100° C. or more higher than a glass transition temperature (Tg) of the pressure-sensitive adhesive layer, and

the pressure-sensitive adhesive layer is in such a state that the polymer particles have a number average particle size (a) of 10 nm to 100 nm and that the ratio (a/b) of the number average particle size (a) to the average distance (b) between adjacent polymer particles is from 80/20 to 99.9/0.1, when observed with a transmission electron microscope.

The pressure-sensitive adhesive layer-attached optical film is preferable a pressure-sensitive adhesive layer-attached polarizing plate including: a polarizing plate including a polarizer and a transparent protective film provided on at least one side of the polarizer; and the pressure-sensitive adhesive layer placed on one side of the polarizing plate, and a depolarization value expressed by a difference (P1−P2) between a degree (P1) of polarization of the polarizing plate and a degree (P2) of polarization of the pressure-sensitive adhesive layer-attached polarizing plate is preferably 0.015 or less.

The present invention also relates to an image display device including at least one piece of the pressure-sensitive adhesive layer-attached optical film.

### Effect of the Invention

A pressure-sensitive adhesive layer formed using a water-dispersible pressure-sensitive adhesive contains polymer particles, which form the main part of emulsion particles, and other components (such as a surfactant, a water-soluble component, and water) existing between the polymer particles (in other words, portions other than the polymer particles, which are separated by the interfaces of the polymer particles, namely, the contours of the polymer particles). Light scattering occurring in such a pressure-sensitive adhesive layer is mainly caused by a difference in refractive index between the polymer particles in the emulsion particles and the components existing between the polymer particles. Specifically, as the content of the components existing between the polymer particles increases, light scattering occurring in the pressure-sensitive adhesive layer increases at the components to cause depolarization. Thus, it is preferred that the content of the components existing between the polymer particles should be low relative to the content of the polymer particles in the emulsion particles. On the other hand, if the content of the components existing between the polymer particles is too low, the emulsion particles can be unstable so that they may form very-large irregular agglomerates to significantly degrade the appearance of the pressure-sensitive adhesive layer, because the components are used to stabilize the emulsion particles.

From the above points of view, the number average particle size (a) of the polymer particles in the emulsion particles, which form the pressure-sensitive adhesive layer of the present invention, is controlled to be in the range of 10 to 100 nm. From the same points of view, the ratio (a/b) of the number average particle size (a) of the acryl-based polymer particles to the average distance (b) between adjacent acryl-based polymer particles in the pressure-sensitive adhesive layer of the present invention is controlled to be in the specified range.

As stated above, the pressure-sensitive adhesive layer of the present invention has a relatively high content of polymer particles derived from emulsion particles and a predetermined low content of the components between the polymer particles, which makes it possible to stabilize the emulsion and to control depolarization to a lower level in the pressure-sensitive adhesive layer. Thus, the pressure-sensitive adhesive layer of the present invention can improve visibility by keeping depolarization at a lower level.

The pressure-sensitive adhesive layer of the present invention is formed by drying a water-dispersible pressure-sensitive adhesive containing emulsion particles. In the forming process, the residual water content at 23° C. and 55% R.H. may be controlled to be from 0.1 to 1% by weight. Controlling the residual water content of the pressure-sensitive adhesive layer within the range makes it possible to reduce the content of water existing between the polymer particles, so that the rate of water-induced change in the refractive index of the portions between the polymer particles can be reduced, which makes it possible to reduce depolarization.

### BRIEF DESCRIPTION OF THE DRAWINGS

FIG. 1 is a TEM image photograph of a pressure-sensitive adhesive layer obtained in Example 1.

FIG. 2 is a TEM image photograph of a pressure-sensitive adhesive layer obtained in Example 2.

### MODE FOR CARRYING OUT THE INVENTION

The pressure-sensitive adhesive layer for an optical film of the present invention is formed by a process including applying a water-dispersible pressure-sensitive adhesive and then drying it. The pressure-sensitive adhesive layer is formed using a water-dispersible pressure-sensitive adhesive that contains emulsion particles including polymer particles emulsified with a surfactant.

In the pressure-sensitive adhesive layer, the polymer particles in the emulsion particles have a number average particle size (a) of 10 to 100 nm when observed with a transmission electron microscope. As the number average particle size (a) becomes smaller, the content of the polymer particles in the pressure-sensitive adhesive layer becomes relatively higher. When the average particle size (a) is 100 nm or less, the content of the polymer particles in the pressure-sensitive adhesive layer is relatively high so that the content of the components between the polymer particles can be relatively low, which makes light scattering less likely to occur, so that depolarization is suppressed. If the number average particle size (a) is more than 100 nm, the content of the polymer particles in the whole of the pressure-sensitive adhesive layer will be relatively low, which can increase the content of the inter-particle part not capable of being filled with the polymer particles as the main component of the emulsion particles even when the emulsion particles form a close-packed structure in the pressure-sensitive adhesive layer. As a result, the surfactant or any other component of the emulsion particles will gather between the polymer particles, so that the concentration of the component having a refractive index different from that of the polymer particles will be high between the particles, which can cause light scattering and undesirably increase depolarization. On the other hand, if the number average particle size (a) is less than 10 nm, the emulsion particles would be more likely to be unstable, so that they may be less likely to exist in the form of primary particles. As a result, the emulsion particles become more likely to exist in the form of secondary particles or agglomerates, which can form coarse particles to undesirably increase the ratio of the part between the particles. From the above points of view, the residual water content is preferably from 0.2 to 0.9% by weight, more preferably from 0.4 to 0.6% by weight. The number average particle size (a) is preferably from 10 to 90 nm, more preferably from 30 to 70 nm.

Additionally, in the pressure-sensitive adhesive layer, the ratio (a/b) of the number average particle size (a) of the polymer particles to the average distance (b) between adjacent polymer particles is from 80/20 to 99.9/0.1. The ratio (a/b) is a value calculated relative to the total of the average number particle size (a: nm) and the average distance (b: nm), which is normalized as 100%. From the same points of view, the ratio (a/b) of the number average particle size (a) of the polymer particles to the average distance (b) between adjacent polymer particles is controlled to be within the specified range, so that the emulsion content of the pressure-sensitive adhesive layer is relatively high, while the component between the polymer particles is allowed to exist at a certain concentration. If the percentage of the average distance (b) is more than 20%, the content of the component having a refractive index different from that of the polymer particles as the main component of the emulsion particles will be high between the particles, so that light scattering can occur due to the refractive index difference and that depolarization can undesirably increase. If the percentage of the average distance (b) is less than 0.1%, the emulsion particles would be more likely to be unstable, so that they may be less likely to exist in the form of primary particles. As a result, the emulsion particles become more likely to exist in the form of secondary particles or agglomerates, which can form coarse particles to undesirably increase the ratio of the part between the particles. From the above points of view, the ratio (a/b) is preferably from 85/15 to 99/1, more preferably from 90/10 to 95/5. The average distance (b) may be from 0.01 to 20 nm, preferably from 0.1 to 13.5 nm, more preferably from 1.5 to 7 nm.

The pressure-sensitive adhesive layer is preferably controlled to have a residual water content of 0.1 to 1% by weight at 23° C. and 55% R.H. If the residual water content is less than 0.1% by weight, the content of water in the pressure-sensitive adhesive layer can be too low so that the pressure-sensitive adhesive layer can be too hard to perform its function sufficiently. On the other hand, if the residual water content is more than 1% by weight, the content of water existing between the polymer particles will be relatively high so that the surfactant and a water-soluble polymer produced together with the polymer particles will each have a relatively high concentration, which can increase the content of the component existing between the particles and having a refractive index different from that of the polymer particles as the main component of the emulsion particles, so that light scattering can occur due to the refractive index difference and that depolarization can undesirably increase. From the above points of view, the residual water content is preferably from 0.2 to 0.9% by weight, more preferably from 0.4 to 0.6% by weight.

In the pressure-sensitive adhesive layer, the surfactant used in the synthesis of the polymer emulsion forms the component existing between the polymer particles. As described above, the content of the component existing between the polymer particles is limited within the specified range in the pressure-sensitive adhesive layer. In addition, as the difference in refractive index between the component and the polymer as the main component of the emulsion particles decreases, light scattering becomes less likely to occur so that depolarization desirably decreases. From this point of view, the surfactant material and the polymer material (e.g., the monomer component used to form the polymer) for the main component of the pressure-sensitive adhesive layer are preferably so selected that the difference in refractive index between the whole of the pressure-sensitive adhesive layer (including the polymer and the surfactant) and the surfactant is 0.1 or less. The refractive index difference is preferably 0.07 or less, more preferably 0.06 or less.

The ratio (a/b) and the refractive index difference are related to each other in view of depolarization. The average percentage (b) for the ratio (a/b) is preferably low, and the refractive index difference is also preferably low. On the other hand, even when the average percentage (b) for the ratio (a/b) is as high as 20%, adjusting the refractive index difference to 0.1 or less makes it possible to reduce depolarization.

The pressure-sensitive adhesive layer for an optical film of the present invention may be produced using a water-dispersible pressure-sensitive adhesive containing any of various types of emulsion particles. The water-dispersible pressure-sensitive adhesive may be of any type such as a rubber-based pressure-sensitive adhesive, an acryl-based pressure-sensitive adhesive, a silicone-based pressure-sensitive adhesive, a polyurethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, or a cellulose-based pressure-sensitive adhesive. The pressure-sensitive adhesive base polymer or the dispersing means is selected depending on the type of the pressure-sensitive adhesive. Examples of the method of producing the water-dispersible pressure-sensitive adhesive include a method of performing emulsion polymerization of any of various monomers, a phase inversion method including performing solution polymerization of any of various monomers and then adding water to convert the solution to an aqueous dispersion system, and a forced dispersion method including dispersing any of various resins with a surfactant or other materials.

Among the pressure-sensitive adhesives, a water-dispersible acryl-based pressure-sensitive adhesive is preferably used in the present invention, because it has a high level of optical transparency and weather resistance or heat resistance and exhibits appropriate wettability and pressure-sensitive adhesive properties such as appropriate cohesiveness and tackiness.

For example, preferably used is a water-dispersible acryl-based pressure-sensitive adhesive containing emulsion particles that contain an acryl-based polymer obtained by performing, in water in the presence of a radical polymerization initiator and a surfactant, emulsion polymerization of a monomer component including an alkyl (meth)acrylate as a main component. As used herein, the term “alkyl (meth)acrylate” means alkyl acrylate and/or alkyl methacrylate, and “(meth)” is used in the same meaning in the description.

For example, the monomer component preferably contains 60 to 99.9% by weight of an alkyl (meth)acrylate having a straight or branched chain alkyl group of 3 to 14 carbon atoms and 0.1 to 10% by weight of a carboxyl group-containing monomer.

The alkyl group of the alkyl (meth)acrylate having a straight or branched chain alkyl group of 3 to 14 carbon atoms may be any of a straight chain or a branched chain. Examples of the alkyl group of 3 to 14 carbon atoms include a n-propyl group, an isopropyl group, a n-butyl group, an isobutyl group, a sec-butyl group, a tert-butyl group, a pentyl group, a neopentyl group, an isoamyl group, a hexyl group, a heptyl group, a 2-ethylhexyl group, an isooctyl group, a nonyl group, an isononyl group, a decyl group, an isodecyl group, a dodecyl group, a tridecyl group, and a tetradecyl group. Among these, alkyl (meth)acrylates with an alkyl group of 3 to 9 carbon atoms are preferred, such as n-butyl (meth)acrylate, 2-ethylhexyl (meth)acrylate, and n-octyl (meth)acrylate.

The alkyl (meth)acrylate having a straight or branched chain alkyl group of 3 to 14 carbon atoms is a main component for imparting adherability to the acryl-based polymer and makes up 60 to 99.9% of the total weight of the monomer component. The content of the alkyl (meth)acrylate having a straight or branched chain alkyl group of 3 to 14 carbon atoms is preferably from 70 to 99% by weight, more preferably from 70 to 95% by weight.

The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate. The carboxyl group-containing monomer is used to improve the tackiness of the pressure-sensitive adhesive and provide stability for the emulsion.

When the content of the carboxyl group-containing monomer is 0.1% by weight or more, mechanical stability can be imparted to the emulsion, so that the formation of aggregates can be prevented when a shear is applied to the emulsion. Setting the content at 10% by weight or less is preferred in order to keep the water-solubility of the pressure-sensitive adhesive layer at a low level and achieve satisfactory moisture durability. The content of the carboxyl group-containing monomer of the total weight of the monomer component is preferably from 0.1 to 10% by weight, more preferably from 0.5 to 7% by weight, and even more preferably from 1 to 5% by weight.

In addition to the monomers listed above, the monomer component used to form the acryl-based polymer may contain one or more copolymerizable monomers having an unsaturated double bond-containing polymerizable functional group such as a (meth)acryloyl group or a vinyl group, so that one or more copolymerizable monomers having such a functional group can be incorporated by copolymerization for purposes such as stabilization of the emulsion, improvement in the adhesion of the pressure-sensitive adhesive layer to a base material such as an optical film, and improvement in the initial tackiness to adherends. The copolymerizable monomer(s) may make up 39% or less of the total weight of the monomer component.

For example, the copolymerizable monomer preferably includes a high-Tg monomer capable of forming a homopolymer with a glass transition temperature (Tg) of 50° C. or more so that the pressure-sensitive adhesive layer can have a higher cohesive strength. For example, the high-Tg monomer may be an alkyl methacrylate having an alkyl group of one or two carbon atoms, specifically, methyl methacrylate or ethyl methacrylate. For example, the high-Tg monomer may also be an aryl (meth)acrylate such as cyclohexyl methacrylate or isobornyl (meth)acrylate; an aromatic ring-containing hydrocarbon ester of (meth)acrylic acid, such as benzyl (meth)acrylate or phenyl (meth)acrylate; or a styrene monomer such as styrene or α-methyl styrene. In particular, methyl methacrylate is preferred. The glass transition temperature (Tg) of the homopolymer is the theoretical glass transition temperature for use in the FOX equation.

The content of the high-Tg monomer is preferably from 0.1 to 39% by weight based on the total weight of the monomer component. When the content of the high-Tg monomer is 0.1% by weight or more, an appropriate level of cohesive strength can be imparted to the pressure-sensitive adhesive layer, which is preferred to suppress foaming of the pressure-sensitive adhesive layer in a high-temperature environment and to provide a satisfactory level of heat durability. When the content is 39% by weight or less, the pressure-sensitive adhesive layer can be prevented from being too hard, which is preferred to suppress peeling in a high-temperature or high-humidity environment and to provide a satisfactory level of heat and humidity durability. The content of the high-Tg monomer is more preferably from 1 to 30% by weight, even more preferably from 5 to 20% by weight.

Examples of copolymerizable monomers, but not limited to, include acid anhydride group-containing monomers such as maleic anhydride and itaconic anhydride; aryl (meth)acrylate such as phenyl (meth)acrylate; vinyl esters such as vinyl acetate and vinyl propionate; epoxy group-containing monomers such as glycidyl (meth)acrylate and methylglycidyl (meth)acrylate; hydroxyl group-containing monomers such as 2-hydroxyethyl (meth)acrylate 2-hydroxypropyl (meth)acrylate and 4-hydroxybutyl (meth)acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

The copolymerizable monomer may be a phosphate group-containing monomer. For example, the phosphate group-containing monomer may be a phosphate group-containing monomer represented by formula (I) below or a salt thereof.

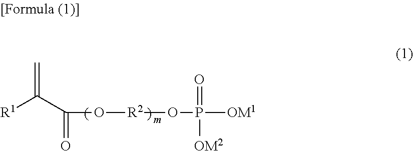

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may comprise random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

The copolymerizable monomer may also be an unsaturated silicone monomer. Examples of the unsaturated silicone monomer include silicone (meth)acrylate monomers and vinyl silicone monomers. Examples of the silicone (meth)acrylate monomers include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, vinyl silicone monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

A polyfunctional monomer may also be used as the copolymerizable monomer for a purpose such as control of the gel fraction of the water-dispersible pressure-sensitive adhesive. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or polyethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; diacetone acrylamide; and compounds having two or more reactive unsaturated double bonds which have different reactivity respectively, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

Among these copolymerizable monomers, a phosphate group-containing monomer or an unsaturated silicone monomer is preferably used so that the aqueous dispersion (emulsion) can be stabilized or the pressure-sensitive adhesive layer made from the emulsion can have reliable adhesion to an adherend such as a glass panel.

The content of the copolymerizable monomer may be appropriately selected depending on the type of each copolymerizable monomer. The content of the phosphate group-containing monomer is preferably from 0.5 to 5% by weight based on the total weight of the monomer component. The content of the unsaturated silicone monomer is preferably from 0.005 to 0.2% by weight based on the total weight of the monomer component.

When the copolymerizable monomer other than the alkoxysilyl group-containing monomer or the phosphate group-containing monomer is a monofunctional monomer, the content of the copolymerizable monomer is preferably 20% by weight or less, more preferably 10% by weight or less, even more preferably 5% by weight or less based on the total weight of the monomer component so that the emulsion can be prevented from having too high viscosity and can be stable. When the copolymerizable monomer is a polyfunctional monomer, the content of the copolymerizable monomer is preferably 5% by weight or less, more preferably 3% by weight or less, even more preferably 1% by weight or less based on the total weight of the monomer component in view of the stability of the emulsion. If the content of a hydrophilic monomer, such as a hydroxyl group-containing monomer, used as the copolymerizable monomer is high, the resulting pressure-sensitive adhesive layer can have high residual water content. In order to control the residual water content in the range of 0.1 to 1% by weight, the content of the hydroxyl group-containing monomer is preferably 4% by weight or less, more preferably 3% by weight or less, even more preferably 1% by weight or less based on the total weight of the monomer component.

The emulsion polymerization of the monomer component may be performed by a conventional method. An aqueous dispersion containing an acryl-based polymer as a base polymer (an emulsion containing emulsion particles) is prepared by this method. In the emulsion polymerization, for example, the surfactant (emulsifying agent), a radical polymerization initiator, and an optional additive such as a chain transfer agent are appropriately added to the monomer component. More specifically, for example, a known emulsion polymerization method may be employed, such as a batch mixing method (batch polymerization method), a monomer dropping method, or a monomer emulsion dropping method. In the monomer dropping method, continuous dropping or divided dropping is appropriately selected. These methods may be appropriately combined. While reaction conditions and so on may be appropriately selected, for example, the polymerization temperature is preferably from about 40 to about 95° C., and the polymerization time is preferably from about 30 minutes to about 24 hours.

The surfactant (emulsifying agent) for use in the emulsion polymerization may be, but not limited to, any of various surfactants commonly used in emulsion polymerization. As the surfactant, an anionic or a nonionic surfactant is generally used. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; and polyoxyethylene distyrenated phenyl ether sulfate ester salts; sodium naphthalenesulfonate-formalin condensate. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-2 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd. ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd, and others).

The content of the surfactant is preferably from 0.6 to 5 parts by weight based on 100 parts by weight of the monomer components. Pressure-sensitive adhesive properties, polymerization stability, mechanical stability, etc. can be improved by controlling the content of the surfactant. The surfactant content is more preferably from 0.6 to 4 parts by weight.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.08 to 0.3 parts by weight, based on 100 parts by weight of the monomer components, while it is appropriately selected. If it is less than 0.02 parts by weight, the radical polymerization initiator may be less effective. If it is more than 1 part by weight, the acryl-based polymer in the aqueous dispersion (polymer emulsion) may have a reduced molecular weight, so that the water-dispersible pressure-sensitive adhesive may have reduced durability. In the case of a redox system initiator, the reducing agent is preferably used in an amount of 0.01 to 1 part by weight based on 100 parts by weight of the total amount of the monomer components.

A chain transfer agent is optionally used to control the molecular weight of the acryl-based polymer. The chain transfer agents used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is from 0.001 to 0.3 parts by weight based on 100 parts by weight of the monomer components.

An emulsion containing acryl-based polymer particles (as emulsion particles) can be prepared by such emulsion polymerization. Such an acryl-based polymer in the form of an emulsion typically has an average particle size of 10 to 100 nm, preferably 10 to 90 nm, more preferably 30 to 70 nm. If the average particle size is more than 100 nm, the content of the polymer particles in the pressure-sensitive adhesive layer will be relatively low, which can increase the content of the inter-particle part not capable of being filled with the polymer particles as the main component of the emulsion particles even when the emulsion particles form a close-packed structure in the pressure-sensitive adhesive layer. As a result, the surfactant or any other component of the emulsion particles will gather between the polymer particles, so that the concentration of the component having a refractive index different from that of the polymer particles will be high between the particles, which can cause light scattering and undesirably increase depolarization. On the other hand, if the average particle size is less than 10 nm, the emulsion particles would be more likely to be unstable, so that they may be less likely to exist in the form of primary particles. As a result, the emulsion particles become more likely to exist in the form of secondary particles or agglomerates, which can form coarse particles to undesirably increase the ratio of the part between the particles.

For maintaining the stability of the emulsion, if the carboxyl group-containing monomer or the like is included in the acryl-based polymer that is contained in the emulsion as a copolymerizable monomer, the carboxyl group-containing monomer or the like should preferably be neutralized. For example, the neutralization can be performed using ammonia, an alkali metal hydroxide, or the like.

In general, the emulsion type acryl-based polymer to the present invention preferably has a weight average molecular weight of 1,000,000 or more. In particular, the weight average molecular weight is preferably from 1,000,000 to 4,000,000 in view of heat resistance or moisture resistance. A weight average molecular weight of less than 1,000,000 is not preferred, because with such a molecular weight, heat resistance or moisture resistance may decrease. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has high gel content and cannot be subjected to GPC (gel permeation chromatography) measurement, which means that it is often difficult to identify the molecular weight by actual measurement.

The emulsion containing the polymer particles for the water-dispersible pressure-sensitive adhesive according to the present invention may also contain a crosslinking agent. Examples of the crosslinking agent that may be used include those commonly used, such as an isocyanate crosslinking agent, an epoxy crosslinking agent, an oxazoline crosslinking agent, an aziridine crosslinking agent, a carbodiimide crosslinking agent, and a metal chelate crosslinking agent. When a functional group-containing monomer is used, these crosslinking agents have the effect of reacting with the functional group incorporated in the acryl-based polymer to form crosslinkage.

The content of the crosslinking agent (on solid basis) to the base polymer such as the acryl-based polymer is, but not limited to, about 10 parts by weight or less based on 100 parts by weight of the solid in the base polymer (on solid basis). The content of the crosslinking agent is preferably from about 0.001 to about 10 parts by weight, more preferably from about 0.01 to about 5 parts by weight.

If necessary, the water-dispersible pressure-sensitive adhesive of the present invention may further appropriately contain any of various additives such as viscosity adjusting agent, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, and ultraviolet ray absorbing agents, silane coupling agents, without departing from the objects of the present invention. The water-dispersible pressure-sensitive adhesive may also contain fine particles to form a light-diffusing pressure-sensitive adhesive layer. These additives may also be added in the form of emulsion.

The pressure-sensitive adhesive layer for an optical film of the present invention is made from the water-dispersible pressure-sensitive adhesive. The pressure-sensitive adhesive layer can be formed by a process including applying the water-dispersible pressure-sensitive adhesive to a substrate (an optical film or a release film) and then drying the adhesive.

The pressure-sensitive adhesive layer-attached optical film of the present invention includes an optical film and the pressure-sensitive adhesive layer or layers placed on one or both sides of the optical film. The pressure-sensitive adhesive layer-attached optical film of the present invention can be formed by a process including applying the water-dispersible pressure-sensitive adhesive to an optical film or a release film and drying the composition. When the pressure-sensitive adhesive layer is formed on a release film, the pressure-sensitive adhesive layer will be transferred and bonded to an optical film.

Various methods may be used in the applying step of the water-dispersible pressure-sensitive adhesive. Examples include roll coating, kiss roll coating, gravure coating, reverse coating, roll brush coating, spray coating, dip roll coating, bar coating, knife coating, air knife coating, curtain coating, lip coating, and extrusion coating using a die coater or the like.

In the applying step, the amount of the application should be controlled so that a pressure-sensitive adhesive layer with a predetermined thickness (post-drying thickness) can be formed. The thickness (post-drying thickness) of the pressure-sensitive adhesive layer is generally set within the range of about 1 μm to about 100 μm, preferably within the range of 5 μm to 50 μm, and more preferably within the range of 10 μm to 40 μm.

Subsequently, the applied water-dispersible pressure-sensitive adhesive is dried to form a pressure-sensitive adhesive layer. The drying temperature is generally from about 80 to about 170° C., preferably from 80 to 160° C., and the drying time period is generally from about 0.5 to about 30 minutes, preferably from 1 to 10 minutes.

The drying temperature is preferably set at a temperature 100° C. or more higher than the glass transition temperature (Tg) of the pressure-sensitive adhesive layer. In general, the glass transition temperature (Tg) of the pressure-sensitive adhesive layer is preferably from −60 to 0° C., more preferably from −50° C. to −10° C. When the drying temperature is set at a temperature 100° C. or more higher than the Tg, a pressure-sensitive adhesive layer with a low residual water content can be formed, which is preferred to reduce the content of water existing between the polymer particles and to control the residual water content in the range of 0.1 to 1% by weight. Thus, the content of the component existing between the polymer particles, such as a water-soluble polymer or the surfactant, can also be reduced, which can reduce a change in refractive index or the like and make light scattering less likely to occur, so that depolarization can be reduced. The drying temperature is more preferably 120° C. or more, even more preferably 150° C. or more, still more preferably 170° C. or more higher than the Tg. If the drying temperature is too high, the release film will be deformed by heat, which will make it difficult to obtain a pressure-sensitive adhesive layer with high thickness uniformity. Thus, the drying temperature is preferably set in the range at most 200° C. higher than the glass transition temperature (Tg) of the pressure-sensitive adhesive layer.

As described above, the pressure-sensitive adhesive layer for an optical film of the present invention provides a lower depolarization value. For example, concerning a pressure-sensitive adhesive layer-attached polarizing plate including a polarizing plate and the pressure-sensitive adhesive layer of the present invention placed on one side of the polarizing plate, the depolarization value may be defined as a difference (P1−P2) between the degree (P1) of polarization of the polarizing plate and the degree (P2) of polarization of the pressure-sensitive adhesive layer-attached polarizing plate. In this case, the depolarization value can be controlled to be as low as 0.015 or less. The depolarization value, which is preferably as low as possible, is more preferably 0.012 or less, even more preferably 0.011 or less. For example, when the above drying temperature requirements are satisfied, the depolarization value can be reduced to 0.011 or less. Concerning the depolarization value, the degree of polarization can be measured as described in EXAMPLES, and the same depolarization value can be obtained regardless of the type of polarizing plate. The polarizing plate used in the determination of the depolarization value preferably has a degree of polarization of 99.000 or more, more preferably 99.900 or more, even more preferably 99.995 or more.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release film may be used as is as a separator for a pressure-sensitive adhesive layer-attached optical film, so that the process can be simplified.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film used for the pressure-sensitive adhesive layer-attached optical film of the present invention is, but not limited to the kinds, used for forming image display device such as liquid crystal display device. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 80 μm or less.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film may be exemplified as other optical layers, such as a reflective plate, a transflective plate, a retardation plate (a half wavelength plate and a quarter wavelength plate included), a viewing angle compensation film, a brightness enhancement film, a surface treatment film or the like, which may be used for formation of a liquid crystal display device etc. These are used in practice as an optical film, or as one layer or two layers or more of optical layers laminated with polarizing plate.

The surface treatment film may also be provided on and bonded to a front face plate. Examples of the surface treatment film include a hard-coat film for use in imparting scratch resistance to the surface, an antiglare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front face plate is also used as a support for a λ/4 plate in a 3D-TV. In a liquid crystal display device, for example, the front face plate is provided above a polarizing plate on the viewer side. When the pressure-sensitive adhesive layer according to the present invention is used, the same effect can be produced using a plastic base material such as a polycarbonate or poly (methyl methacrylate) base material for the front face plate, as well as using a glass base material.

Although an optical film with the above described optical layer laminated to the polarizing plate may be formed by a method in which laminating is separately carried out sequentially in manufacturing process of a liquid crystal display device or the like, an optical film in a form of being laminated beforehand has an outstanding advantage that it has excellent stability in quality and assembly workability, and thus manufacturing processes ability of a liquid crystal display device or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive layer-attached optical film of the present invention is preferably used to form various types of image display devices such as liquid crystal display devices. Liquid crystal display devices may be produced according to conventional techniques. Specifically, liquid crystal display devices are generally produced by appropriately assembling a display device panel such as a liquid crystal cell and the pressure-sensitive adhesive layer-attached optical film and optionally other components such as a lighting system and incorporating a driving circuit according to any conventional technique, except that the pressure-sensitive adhesive layer-attached optical film of the present invention is used. Any type of liquid crystal cell may also be used such as a TN type, an STN type, a π type, a VA type and an IPS type.

Suitable liquid crystal display devices, such as liquid crystal display device with which the above pressure-sensitive adhesive layer-attached optical film has been provided on one side or both sides of the display device panel such as a liquid crystal cell, and with which a backlight or a reflective plate is used for a lighting system may be manufactured. In this case, the pressure-sensitive adhesive layer-attached optical film of the present invention may be provided on one side or both sides of the display device panel such as a liquid crystal cell. When providing the pressure-sensitive adhesive layer-attached optical films on both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display device: OLED) will be explained. Generally, in organic EL display device, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display device emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and, as is expected, there is a strong non-linear relationship between electric current and luminescence strength accompanied by rectification nature to applied voltage.

In an organic EL display device, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display device of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display device side of the organic EL display device looks like mirror if viewed from outside.

In an organic EL display device containing an organic electro luminescence illuminant equipped with a transparent electrode on a surface side of an organic luminescence layer that emits light by impression of voltage, and at the same time equipped with a metal electrode on aback side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display device is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

As described above, in order to block mirror reflection, the organic EL panel of an organic EL display device may use an elliptically or circularly polarizing plate having a combination of a retardation plate and a polarizing plate with the pressure-sensitive adhesive layer interposed therebetween. Alternatively, without an elliptically or circularly polarizing plate directly bonded to an organic EL panel, a laminate formed by bonding an elliptically or circularly polarizing plate to a touch panel with the pressure-sensitive adhesive layer interposed therebetween may be used in an organic EL panel.

The present invention is applicable to various types of touch panel, such as optical, ultrasonic, capacitance, and resistive touch panels. A resistive touch panel includes: a touch-side, touch panel-forming electrode plate having a transparent conductive thin film; and a display device-side, touch panel-forming electrode plate having a transparent conductive thin film, wherein the electrode plates are opposed to each other with spacers interposed therebetween in such a manner that the transparent conductive thin films are opposed to each other. A capacitance touch panel generally includes a transparent conductive film that has a transparent conductive thin film in a specific pattern and is formed over the surface of a display device unit. The pressure-sensitive adhesive layer-attached optical film according to the present invention may be used on any of the touch side and the display device side.

### EXAMPLES

Hereinafter, the present invention is more specifically described with reference to the examples, which however are not intended to limit the present invention. Unless otherwise specified, “parts” and “%” in each example are all by weight.

### Production Example 1

### Preparation of Monomer Emulsion

To a vessel were added 780 parts of butyl acrylate, 20 parts of acrylic acid, and 200 parts of methyl methacrylate, and mixed to form a monomer component. Subsequently, 22 parts of AQUALON HS-10 (manufactured by DAI-ICHI KOGYO SEIYAKU CO., LTD) as a reactive surfactant and 127 parts of ion-exchanged water were added to 200 parts of the monomer component prepared with the above composition. The resulting mixture was forcedly emulsified by stirring at 6,000 (rpm) for 5 minutes using a homomixer (manufactured by PRIMIX Corporation), so that a monomer emulsion (A-1) was obtained.

To another vessel were added 600 parts of the monomer component prepared with the above composition, 8 parts of AQUALON HS-10 (manufactured by DAI-ICHI KOGYO SEIYAKU CO., LTD.) as a reactive surfactant, and 382 parts of ion-exchanged water. The resulting mixture was forcedly emulsified by stirring at 6,000 (rpm) for 5 minutes using a homomixer (manufactured by PRIMIX Corporation), so that a monomer emulsion (A-2) was obtained.

### (Preparation of Emulsion-Type Acryl-Based Pressure-Sensitive Adhesive)

Subsequently, 349 parts of the monomer emulsion (A-1) prepared as described above and 874 parts of ion-exchanged water were added to a reaction vessel equipped with a condenser tube, a nitrogen-introducing tube, a thermometer, a dropping funnel, and a stirring blade. Subsequently, after the air in the reaction vessel was sufficiently replaced with nitrogen gas, 0.6 parts of ammonium persulfate was added to the vessel, and was subjected to polymerization at 60° C. for 1 hour with stirring. Subsequently, 990 parts of the monomer emulsion (A-2) was added dropwise to the reaction vessel over 3 hours, while the reaction vessel was kept at 60° C., and was then subjected to polymerization for 3 hours, so that a polymer emulsion with a solid concentration of 46.0% was obtained. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 45.2%, respectively.

### Production Example 2

Monomer emulsions (A-1) and (A-2) were prepared as in Production Example 1, except that the amount of AQUALON HS-10 (manufactured by DAI-ICHI KOGYO SEIYAKU CO., LTD.) as a reactive surfactant was changed to 44 parts in the preparation of the monomer emulsion (A-1) and that the amount of AQUALON HS-10 (manufactured by DAI-ICHI KOGYO SEIYAKU CO., LTD.) as a reactive surfactant was changed to 16 parts in the preparation of the monomer emulsion (A-2). A polymer emulsion with a solid concentration of 46.2% was obtained as in Production Example 1, except that the resulting monomer emulsions (A-1) and (A-2) were used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 45.5%, respectively.

### Production Example 3

Monomer emulsions (A-1) and (A-2) were prepared as in Production Example 1, except that the amount of AQUALON HS-10 (manufactured by DAI-ICHI KOGYO SEIYAKU CO., LTD.) as a reactive surfactant was changed to 11 parts in the preparation of the monomer emulsion (A-1) and that the amount of AQUALON HS-10 (manufactured by DAI-ICHI KOGYO SEIYAKU CO., LTD.) as a reactive surfactant was changed to 4 parts in the preparation of the monomer emulsion (A-2). A polymer emulsion with a solid concentration of 45.8% was obtained as in Production Example 1, except that the resulting monomer emulsions (A-1) and (A-2) were used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 45.0%, respectively.

### Production Example 4

A monomer emulsion (A-1) was prepared as in Production Example 1, expect that 22 parts of LAVELIN FP (manufactured by DAI-ICHI KOGYO SEIYAKU CO., LTD.) as a polymer-type surfactant was used instead of AQUALON HS-10 (manufactured by DAI-ICHI KOGYO SEIYAKU CO., LTD.) as a reactive surfactant. A polymer emulsion with a solid concentration of 45.6% was obtained as in Production Example 1, except that the resulting monomer emulsions (A-1) was used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 44.8%, respectively.

### Production Example 5

Monomer emulsions (A-1) and (A-2) were prepared as in Production Example 1, except that a monomer component of 780 parts of butyl acrylate, 20 parts of acrylic acid, and 200 parts of styrene was used instead. A polymer emulsion with a solid concentration of 45.8% was obtained as in Production Example 1, except that the resulting monomer emulsions (A-1) and (A-2) were used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 45.0%, respectively.

### Production Example 6

Monomer emulsions (A-1) and (A-2) were prepared as in Production Example 1, except that a monomer component of 980 parts of 2-ethylhexyl acrylate and 20 parts of acrylic acid, was used instead. A polymer emulsion with a solid concentration of 45.8% was obtained as in Production Example 1, except that the resulting monomer emulsions (A-1) and (A-2) were used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 45.0%, respectively.

### Production Example 7

### For Comparison

Monomer emulsions (A-1) and (A-2) were prepared as in Production Example 1, except that the amount of AQUALON HS-10 (manufactured by DAI-ICHI KOGYO SEIYAKU CO., LTD.) as a reactive surfactant was changed to 2 parts in the preparation of the monomer emulsion (A-1) and that the amount of AQUALON HS-10 (manufactured by DAI-ICHI KOGYO SEIYAKU CO., LTD.) as a reactive surfactant was changed to 2 parts in the preparation of the monomer emulsion (A-2). A polymer emulsion with a solid concentration of 45.4% was obtained as in Production Example 1, except that the resulting monomer emulsions (A-1) and (A-2) were used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 44.6%, respectively.

### Production Example 8

### For Comparison

### Preparation of Aqueous Dispersion of Clay Mineral

A mixture of 890 parts of ion-exchanged water and 100 parts of LUCENTITE SPN (a clay mineral surface-treated with a quaternary ammonium compound having a hydroxyl-terminated polypropylene oxide group (a cationic-nonionic dispersant), the content ratio of the clay mineral/the cationic-nonionic dispersant=40/60 (by weight), manufactured by CO-OP CHEMICAL CO., LTD.) was prepared and allowed to stand at 23° C. for 96 hours. Subsequently, 10 parts of AQUALIC TL-37 (sodium acrylate/sodium maleate copolymer, an anionic dispersant, manufactured by NIPPON SHOKUBAI CO., LTD.) was added to the mixture. The resulting mixture was dispersed using a homogenizer (manufactured by PRIMIX Corporation) at 1,000 (rpm) for 15 minutes, while heat was removed from it by cooling in an ice-water bath. The dispersion was then filtered through a nylon mesh (#80), so that an aqueous dispersion of 10% LUCENTITE SPN (4% clay mineral) was obtained.

### (Preparation of Emulsion Mixture)

The polymer emulsion obtained in Production Example 1 was mixed with the aqueous dispersion of 10% LUCENTITE SPN (4% clay mineral) in such a manner that the weight ratio of the polymer/the clay mineral/the cationic-nonionic dispersant (the cationic-nonionic dispersant on the surface of the clay mineral (hereinafter the same applies))/the anionic dispersant was 100/4/6/1. Subsequently, 0.5 parts of ARON B-500 (manufactured by TOAGOSEI CO., LTD.) as a thickener was added to 100 parts of the emulsion mixture.

### Production Example 9

### For Comparison

Monomer emulsions (A-1) and (A-2) were prepared as in Production Example 1, except that a monomer component of 700 parts of butyl acrylate, 50 parts of acrylic acid, 200 parts of methyl methacrylate and 50 parts of 2-hydroxyethyl methacrylate was used instead. A polymer emulsion with a solid concentration of 46.8% was obtained as in Production Example 1, except that the resulting monomer emulsions (A-1) and (A-2) were used instead. Subsequently, after the polymer emulsion was cooled to room temperature, 10% ammonia water was added thereto, so that an emulsion-type acryl-based pressure-sensitive adhesive was obtained whose pH and solid concentration were adjusted to 8 and 45.6%, respectively.

### Example 1

### Formation of Pressure-Sensitive Adhesive Layer and Preparation of Pressure-sensitive Adhesive Layer-Attached Polarizing Plate

The emulsion-type acryl-based pressure-sensitive adhesive obtained in Production Example 1 was applied to a release film (Diafoil MRF-38, manufactured by Mitsubishi Chemical Polyester Co., Ltd., a polyethylene terephthalate backing) with a die coater so that a 20-μm-thick coating could be formed after drying, and then the coating was dried at 120° C. for 5 minutes to form a pressure-sensitive adhesive layer. The pressure-sensitive adhesive layer was bonded to each of two different polarizing plates, so that two different pressure-sensitive adhesive layer-attached polarizing plates were obtained. One of the two different polarizing plates (polarizing plate (1)) was prepared by the process described below. The polarizing plate (1) had a degree of polarization of 99.99960. The other polarizing plate (polarizing plate (2)) used was TEG-DU (product name) manufactured by NITTO DENKO Corporation (99.9633 in degree of polarization).

### <Preparation of Polarizing Plate (1)>

An 80-μm-thick polyvinyl alcohol film was stretched to 3 times between rollers different in velocity ratio, while it was dyed in a 0.3% iodine solution at 30° C. for 1 minute. The film was then stretched to a total stretch ratio of 6 times, while it was immersed in an aqueous solution containing 4% boric acid and 10% potassium iodide at 60° C. for 0.5 minutes. Subsequently, the film was cleaned by immersion in an aqueous solution containing 1.5% potassium iodide at 30° C. for 10 seconds, and then dried at 50° C. for 4 minutes to give a polarizer. An 80-μm-thick saponified triacetylcellulose film was bonded to one side of the polarizer with a polyvinyl alcohol-based adhesive. A 70-μm-thick cyclic olefin-based resin film (ZEONOR (trade name) manufactured by ZEON CORPORATION) was bonded to the other side of the polarizer with a polyvinyl alcohol-based adhesive, so that the polarizing plate (1) was obtained.

### Examples 2 to 9 and Comparative Examples 1 to 5

### Formation of Pressure-Sensitive Adhesive Layer and Preparation of Pressure-Sensitive Adhesive Layer-Attached Polarizing Plate

A pressure-sensitive adhesive layer was formed as in Example 1, except that the type of the emulsion-type acryl-based pressure-sensitive adhesive and the drying temperature were changed as shown in Table 1. Two different pressure-sensitive adhesive layer-attached polarizing plates were prepared as in Example 1, except that the resulting pressure-sensitive adhesive layer was used instead.

Each composition ratio (weight ratio) shown in Table 1 indicates the content of each monomer in each monomer component. The glass transition temperature and the refractive index of each emulsion-type acryl-based pressure-sensitive adhesive (pressure-sensitive adhesive layer) shown in Table 1 were measured by the methods described below.

### <Method of Measuring Glass Transition Temperature>

The glass transition temperature (Tg) of the pressure-sensitive adhesive layer was measured with a differential scanning calorimeter (DSC220 (instrument name) manufactured by Seiko Instruments Inc.). Five mg of the pressure-sensitive adhesive layer was placed in an aluminum pan and measured under the following conditions: temperature, −120° C. to 150° C.; temperature rise, 20° C./minute.

### <Method of Measuring Refractive Index>

The refractive index was measured with a multi-wavelength Abbe refractometer DR-M2 (manufactured by ATAGO CO., LTD., measurement light source: sodium lamp (589.3 nm); measurement temperature conditions: 23° C., 65% R.H.). The aqueous dispersion for the emulsion pressure-sensitive adhesive was applied to one side of a silicone-treated polyethylene terephthalate film, and dried to form a 20-μm-thick pressure-sensitive adhesive layer, of which the refractive index was measured. The surfactant solution (98% or more in purity) used in each example was measured for its refractive index. It will be understood that the pressure-sensitive adhesive layer can also be taken out of the pressure-sensitive adhesive layer-attached polarizing plate and then measured for its refractive index.

The pressure-sensitive adhesive layer obtained in each of the examples and the comparative examples was measured for physical properties as described below. The pressure-sensitive adhesive layer and the pressure-sensitive adhesive layer-attached polarizing plate obtained in each of the examples and the comparative examples were evaluated as described below. The results are shown in Table 1.

<Method of Determining Number Average Particle Size (a)>

Only the pressure-sensitive adhesive layer was taken out of the pressure-sensitive adhesive layer-attached polarizing plate and dyed with ruthenic acid. The dyed pressure-sensitive adhesive layer was encapsulated with epoxy resin and then sliced into 50-nm-thick ultrathin section samples with a microtome. The prepared samples were observed with H-7650, a transmission electron microscope (TEM) manufactured by Hitachi High-Technologies Corporation. The component between the polymer particles (in other words, the component other than the polymer particles, which is separated by the interface of each polymer particle, namely, the contour of each polymer particle) was defined as the portion densely dyed with ruthenium, while the polymer particle was defined as the portion relatively lightly dyed on the inner side. The resulting image was processed into a photograph using image processing software, and the number average particle size (a) of the polymer particles was determined from the photograph. In the calculation of the number average particle size (a), 100 or more polymer particle samples were measured for size (maximum particle size) in each photograph, and the average of the measurements was calculated. When the image processing was performed, the maximum length of each particle was determined to be the size of each particle in the method of calculating the particle size.

<Method of Determining the Ratio (a/b)>

The average distance (b) between adjacent polymer particles was determined from the photograph used in the method of determining the number average particle size (a). Specifically, in each photograph, the length of each densely stained portion was determined to be the distance between adjacent polymer particles. It should be noted that when the distance between two adjacent polymer particles is determined, the length of the densely dyed portion depends on what position of the polymer particle is subjected to the measurement. Thus, among the lengths of the portion, the length of the shortest part was determined to be the distance between adjacent polymer particles. The number of the samples measured was 100 (for example, if one polymer particle is surrounded by five adjacent polymer particles, the number of the samples is 5 for the single central polymer particle). The distances between polymer particles were averaged for 100 samples when the average distance (b) between adjacent polymer particles was determined. The ratio (a/b) is calculated relative to the total of the average number particle size (a: nm) and the average distance (b: nm), which is normalized as 100%.

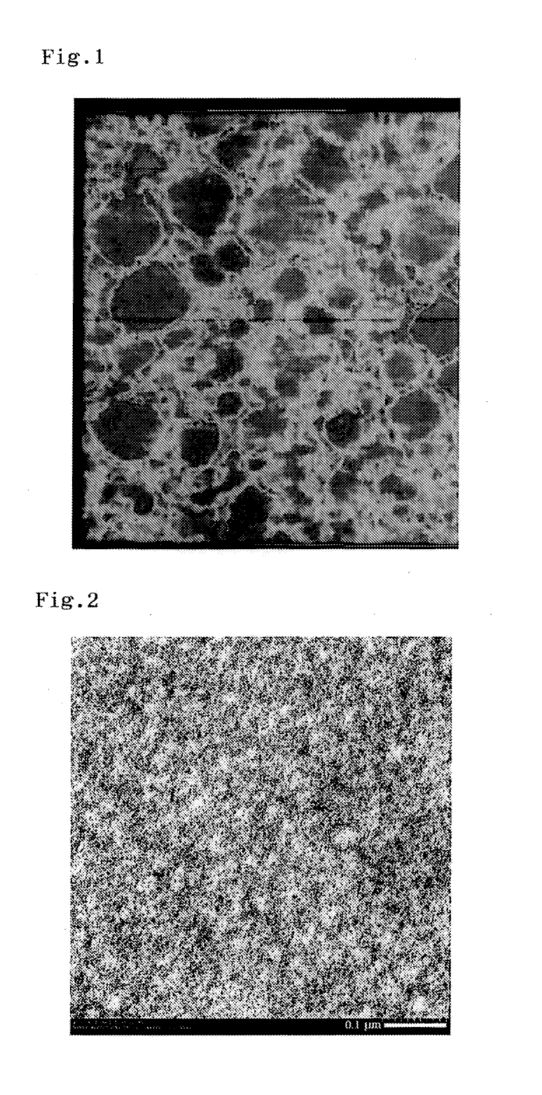

FIG. 1 is a TEM image photograph of the pressure-sensitive adhesive layer of Example 1. The size of the image is 605 nm×606 nm. The number average particle size (a) was 60 nm, and the average distance (b) between adjacent polymer particles was 8 nm. The ratio (a/b) was about 88/12. FIG. 2 is a TEM image photograph of the pressure-sensitive adhesive layer of Example 2. The size of the image is 570 nm×570 nm. The number average particle size (a) was 37 nm, and the average distance (b) between adjacent polymer particles was 3 nm. The ratio (a/b) was about 92/8.

### <Method of Determining Residual Water Content>

Only the pressure-sensitive adhesive layer was taken out of the pressure-sensitive adhesive layer-attached polarizing plate and allowed to stand in an environment at 23° C. and 55% R.H. for 24 hours. The stored pressure-sensitive adhesive layer sample was cut into a 0.5 g piece, which was placed in a heating furnace at 150° C.±1° C. and measured with a Karl Fischer water analyzer (Titrino plus 870/3N (product name) manufactured by SIBATA SCIENTIFIC TECHNOLOGY LTD.) while nitrogen gas (200 ml/minute) was bubbled into the solution in the titration cell.

### <Depolarization Value>

The degrees of polarization of the polarizing plate and the pressure-sensitive adhesive layer-attached polarizing plate were determined using an integrating sphere-equipped spectrophotometer (V7100 manufactured by JASCO Corporation). The degree of polarization is calculated from the formula below using the minimum transmittance (K₂) and the maximum transmittance (K₁). The minimum transmittance (K₂) was measured when the transmission axis of the polarizing plate or the pressure-sensitive adhesive layer-attached polarizing plate was placed orthogonal to the plane of vibration of the polarized light from the prism, and the maximum transmittance (K₂) was measured when the polarizing plate or the pressure-sensitive adhesive layer-attached polarizing plate was rotated by 90 degrees.

Degree (%) of polarization={(K₂−K₁)/(K₂+K₂)}×100

Each transmittance was expressed by a Y value corrected for luminosity in the two-degree visual field (C illuminant) according to JIS Z 8701, which was calculated relative to the transmittance (normalized as 100%) for completely polarized light obtained through a Glan-Taylor prism polarizer. The measured degree (P1) of polarization of the polarizing plate and the measured degree (P2) of polarization of the pressure-sensitive adhesive layer-attached polarizing plate were used to calculate the difference (P1−P2) between them as the depolarization value.

The pressure-sensitive adhesive layer-attached polarizing plate obtained in each of the examples and the comparative examples was used to form liquid crystal display devices A and B as described below.

### <<Liquid Crystal Display Device A>>

The liquid crystal panel was taken out of a commercial liquid crystal display device (a 46-inch liquid crystal television, Bravia KDL-46WS (trade name) manufactured by SONY CORPORATION) including a VA-mode liquid crystal cell, and all optical films including polarizing plates placed on the upper and lower sides of the liquid crystal cell were removed. The liquid crystal cell, of which the front and rear glass plates were cleaned, was named liquid crystal cell A. The pressure-sensitive adhesive layer side of the pressure-sensitive adhesive layer-attached polarizing plate obtained in each of the examples and the comparative examples was bonded to the viewer side of the liquid crystal cell A in such a manner that the direction of the absorption axis of the polarizing plate was substantially parallel to the direction of the long side of the liquid crystal cell A. Subsequently, the pressure-sensitive adhesive layer side of the same pressure-sensitive adhesive layer-attached polarizing plate obtained in each of the examples and the comparative examples was also bonded to the opposite side (backlight side) of the liquid crystal cell A from the viewer side in such a manner that the direction of the absorption axis of the polarizing plate was substantially perpendicular to the direction of the long side of the liquid crystal cell A. The product was named liquid crystal panel A. The directions of the absorption axes of the polarizing plates of the pressure-sensitive adhesive layer-attached polarizing plates on the viewer and backlight sides of the liquid crystal panel A were substantially perpendicular to each other. The liquid crystal panel A was combined with the original liquid crystal display device backlight unit to form a liquid crystal display device A.

### <<Liquid Crystal Display Device B>>

A liquid crystal display device B was prepared as in the case of the liquid crystal display device A, except that a commercial liquid crystal display device (a 10-inch note PC, dynabook SS (trade name) manufactured by TOSHIBA CORPORATION) including a TN-mode liquid crystal cell was used instead.

### <Method of Determining Contrast>

The contrast ratios (1) and (2) were determined in the normal direction of the liquid crystal display devices A and B. The contrast ratios were determined as follows. Thirty minutes after the backlight was turned on in a darkroom at 23° C., Y values in the XYZ color system were measured using BM-5 (product name) manufactured by TOPCON CORPORATION, whose lens was placed 50 cm above the panel, when a white image was displayed and when a black image was displayed. The Y value of the white image (YW: white luminance) and the Y value of the black image (YB: black luminance) were used to calculate the contrast ratio (YW/YB) in the normal direction. The contrast (1) of the liquid crystal display device A is preferably 2,600 or more, more preferably 2,700 or more, 2,800 or more, or 2,900 or more, even more preferably 3,000 or more. The contrast (2) of the liquid crystal display device B is preferably 500 or more, more preferably 540 or more or 560 or more, even more preferably 600 or more.

TABLE 1

| | | | | | | | | Drying conditions | |
|---|---|---|---|---|---|---|---|---|---|
| | | | | | | | | | Difference |
| | | | | | | | | | between |
| | Emulsion-type acryl-based pressure-sensitive adhesive | | | | | | | | drying |
| | | Acryl-based polymer | | Refractive index | | | Glass | | temperature |
| | | | Weight | Acryl- | | Refractive | transition | Drying | and glass |
| | | Monomer | ratio | based | | index | temperature | temperature | transition |
| | Type | composition | (%) | polymer | Surfactant | difference | (° C.) | (° C.) | temperature |
| Example 1 | Production | BA/AA/MMA | 78/2/20 | 1.479 | 1.533 | 0.054 | −23.2 | 120 | 143.2 |
| | Example 1 | | | | | | | | |
| Example 2 | Production | BA/AA/MMA | 78/2/20 | 1.479 | 1.533 | 0.054 | −23.2 | 120 | 143.2 |
| | Example 2 | | | | | | | | |
| Example 3 | Production | BA/AA/MMA | 78/2/20 | 1.479 | 1.533 | 0.054 | −23.2 | 120 | 143.2 |
| | Example 3 | | | | | | | | |
| Example 4 | Production | BA/AA/MMA | 78/2/20 | 1.479 | 1.533 | 0.054 | −23.2 | 150 | 173.2 |
| | Example 1 | | | | | | | | |
| Example 5 | Production | BA/AA/MMA | 78/2/20 | 1.479 | 1.533 | 0.054 | −23.2 | 80 | 103.2 |
| | Example 1 | | | | | | | | |
| Example 6 | Production | BA/AA/MMA | 78/2/20 | 1.479 | 1.590 | 0.111 | −23.2 | 120 | 143.2 |
| | Example 4 | | | | | | | | |
| Example 7 | Production | BA/AA/St | 78/2/20 | 1.503 | 1.533 | 0.030 | −23.6 | 120 | 143.6 |
| | Example 5 | | | | | | | | |
| Example 8 | Production | 2EHA/AA | 98/2 | 1.470 | 1.533 | 0.063 | −53.1 | 120 | 173.1 |
| | Example 6 | | | | | | | | |
| Example 9 | Production | BA/AA/MMA | 78/2/20 | 1.479 | 1.533 | 0.054 | −23.2 | 160 | 183.2 |
| | Example 2 | | | | | | | | |
| Comparative | Production | BA/A/MMA | 78/2/20 | 1.479 | 1.533 | 0.054 | −23.2 | 120 | 143.2 |
| Example 1 | Example 7 | | | | | | | | |
| Comparative | Production | BA/AA/MMA | 78/2/20 | 1.479 | 1.533 | 0.054 | −23.2 | 120 | 143.2 |
| Example 2 | Example 8 | | | | | | | | |
| Comparative | Production | BA/AA/MMA/HEMA | 70/5/20/5 | 1.479 | 1.533 | 0.054 | −15.5 | 120 | 135.5 |
| Example 3 | Example 9 | | | | | | | | |
| Comparative | Production | BA/A/MMA | 78/2/20 | 1.479 | 1.533 | 0.054 | −23.2 | 40 | 63.2 |
| Example 4 | Example 1 | | | | | | | | |
| Comparative | Production | BA/AA/MMA | 78/2/20 | 1.479 | 1.590 | 0.111 | −23.2 | 40 | 63.2 |
| Example 5 | Example 4 | | | | | | | | |

| | Pressure-sensitive adhesive layer | | | | | | | |
|---|---|---|---|---|---|---|---|---|
| | State of emulsion | | | | | | | |
| | particles | | | | Evaluations | | | |
| | Number | Average | | | | | Contrast | |
| | average | distance | | Residual | Depolarization | | Liquid | Liquid |
| | particle | between | | water | Polarizing | Polarizing | crystal | crystal |
| | size | interfaces | Ratio | content | plate | plate | display | display |
| | (a: nm) | (b: nm) | (a/b) | (%) | (1) | (2) | device A | device B |
| Example 1 | 60 | 8 | 88/12 | 0.52 | 0.0122 | 0.0087 | 3556 | 578 |
| Example 2 | 37 | 3 | 92/8 | 0.71 | 0.0068 | 0.0061 | 3815 | 625 |
| Example 3 | 85 | 15 | 85/15 | 0.58 | 0.0128 | 0.0097 | 3610 | 565 |
| Example 4 | 62 | 7 | 90/10 | 0.46 | 0.0105 | 0.0078 | 3723 | 602 |
| Example 5 | 56 | 12 | 82/18 | 0.81 | 0.0146 | 0.0113 | 3225 | 645 |
| Example 6 | 60 | 8 | 88/12 | 0.52 | 0.0135 | 0.0112 | 3358 | 540 |
| Example 7 | 65 | 7 | 90/10 | 0.46 | 0.0122 | 0.0090 | 3515 | 585 |
| Example 8 | 70 | 8 | 90/10 | 0.42 | 0.0142 | 0.0113 | 3219 | 531 |
| Example 9 | 40 | 1 | 98/2 | 0.58 | 0.0044 | 0.0040 | 3790 | 618 |
| Comparative | 130 | 23 | 85/15 | 0.45 | 0.0196 | 0.0165 | 2205 | 456 |
| Example 1 | | | | | | | | |
| Comparative | 65 | 38 | 63/37 | 0.49 | 0.0362 | 0.0326 | 1606 | 406 |
| Example 2 | | | | | | | | |
| Comparative | 70 | 21 | 77/23 | 2.31 | 0.0235 | 0.0175 | 1895 | 425 |
| Example 3 | | | | | | | | |
| Comparative | 53 | 18 | 75/25 | 3.52 | 0.2056 | 0.1541 | 1295 | 308 |
| Example 4 | | | | | | | | |
| Comparative | 55 | 16 | 78/22 | 2.13 | 0.3512 | 0.2149 | 1056 | 291 |
| Example 5 | | | | | | | | |

In the table, BA represents butyl acrylate (228.15 K), AA acrylic acid (379.15 K), MMA methyl methacrylate (378.15 K), St styrene (373.15 K), 2EHA 2-ethylhexyl acrylate (218.15 K), and HEMA 2-hydroxyethyl methacrylate (328.15 K). Each parenthesized temperature is the glass transition temperature (K) of a homopolymer of each monomer, which is used in the calculation of the glass transition temperatures.

1. A pressure-sensitive adhesive layer for an optical film,
the pressure-sensitive adhesive layer being formed by a process comprising applying a water-dispersible pressure-sensitive adhesive containing emulsion particles comprising polymer particles emulsified with a surfactant and then drying the applied water-dispersible pressure-sensitive adhesive, and
the pressure-sensitive adhesive layer being in such a state that the polymer particles have a number average particle size (a) of 10 nm to 100 nm and that the ratio (a/b) of the number average particle size (a) to the average distance (b) between adjacent polymer particles is from 80/20 to 99.9/0.1, when the pressure-sensitive adhesive layer being observed with a transmission electron microscope.

2. The pressure-sensitive adhesive layer for an optical film according to claim 1, wherein the pressure-sensitive adhesive layer has a residual water content of 0.1% by weight to 1% by weight at 23° C. and 55% R.H.

3. The pressure-sensitive adhesive layer for an optical film according to claim 1, wherein a difference between a refractive index of the pressure-sensitive adhesive layer and a refractive index of the surfactant is 0.1 or less.

4. The pressure-sensitive adhesive layer for an optical film according to claim 1, wherein the polymer particles have a number average particle size (a) of 10 nm to 90 nm.

5. The pressure-sensitive adhesive layer for an optical film according to claim 1, wherein the water-dispersible pressure-sensitive adhesive contains emulsion particles comprising acryl-based polymer particles obtained by emulsion polymerization of, in the presence of a radical polymerization initiator and a surfactant, a monomer component containing 60 to 99.9% by weight of an alkyl (meth)acrylate having a straight or branched chain alkyl group of 3 to 14 carbon atoms and 0.1 to 10% by weight of a carboxyl group-containing monomer.

6. The pressure-sensitive adhesive layer for an optical film according to claim 5, wherein the monomer component contains 39% by weight or less of a copolymerizable monomer, and the copolymerizable monomer includes a high-Tg monomer capable of forming a homopolymer with a glass transition temperature (Tg) of 50° C. or more.

7. The pressure-sensitive adhesive layer for an optical film according to claim 6, wherein the high-Tg monomer is a styrene monomer and/or an alkyl methacrylate having an alkyl group of 1 or 2 carbon atoms.

8. The pressure-sensitive adhesive layer for an optical film according to claim 1, wherein the drying in the process of forming the pressure-sensitive adhesive layer is performed at a temperature 100° C. or more higher than a glass transition temperature (Tg) of the pressure-sensitive adhesive layer.

9. A method for producing the pressure-sensitive adhesive layer for an optical film according to claim 1,
the method comprising the steps of: applying a water-dispersible pressure-sensitive adhesive containing emulsion particles comprising polymer particles emulsified with a surfactant; and drying the applied water-dispersible pressure-sensitive adhesive to form the pressure-sensitive adhesive layer, wherein
the drying is performed at a temperature 100° C. or more higher than a glass transition temperature (Tg) of the pressure-sensitive adhesive layer, and
the pressure-sensitive adhesive layer is in such a state that the polymer particles have a number average particle size (a) of 10 nm to 100 nm and that the ratio (a/b) of the number average particle size (a) to the average distance (b) between adjacent polymer particles is from 80/20 to 99.9/0.1, when observed with a transmission electron microscope.

10. A pressure-sensitive adhesive layer-attached optical film, comprising an optical film and the pressure-sensitive adhesive layer for an optical film according to claim 1 placed on at least one side of the optical film.

11. The pressure-sensitive adhesive layer-attached optical film according to claim 10, which is a pressure-sensitive adhesive layer-attached polarizing plate comprising: a polarizing plate comprising a polarizer and a transparent protective film provided on at least one side of the polarizer; and the pressure-sensitive adhesive layer placed on one side of the polarizing plate, wherein
a depolarization value expressed by a difference (P1−P2) between a degree (P1) of polarization of the polarizing plate and a degree (P2) of polarization of the pressure-sensitive adhesive layer-attached polarizing plate is 0.015 or less.

12. An image display device comprising at least one piece of the pressure-sensitive adhesive layer-attached optical film according to claim 10.
